(19) United States
(12) Patent Application Publication
(10) Pub. No.: US 2010/0071443 A1
(43) Pub. Date: Mar. 25, 2010

(54) Temperature-controlled rheometer

(76) Inventors: Nathan Wrench, Cambridge (GB); Benjamin Gordon, Cambridge (GB); Kevin Rathbone, Cambridge (GB); Andrew Gow, Cambridge (GB)

Correspondence Address: KRISTOFER E. ELBING, 187 PELHAM ISLAND ROAD, WAYLAND, MA, 01778, US

(21) Appl. No.: 12/284,892

(22) Filed: Sep. 25, 2008

(51) Int. Cl. G01N 11/14; G01N 25/00

(52) U.S. Cl. 73/54.28; 73/54.42

(57) ABSTRACT

In one general aspect, a rheometer for measuring properties of a sample is disclosed. It can include a first part having a drive portion operatively connected to an actuator and having a contact surface for contacting the sample. The rheometer also includes a second part that has another contact surface for contacting the sample. A first heater is positioned to heat the first part, a second heater is positioned to heat the second part, and a heat pump can heat and cool both the first and second parts.

### FIELD OF THE INVENTION

This invention relates to rheometers, including rheometers that are designed to minimize sample temperature variations.

### BACKGROUND OF THE INVENTION

Rheology is the study of flow and deformation of materials. The characteristics of materials generally vary with temperature, so testing should be performed at a known temperature. Some materials, such as asphalt, are particularly sensitive to temperature variations, and rheometers for these materials are generally designed so that temperature variations across the sample are kept small.

As shown in FIG. 1, a basic rheometer arrangement 10 holds a sample material 12 between an upper geometry 14 and a lower geometry 16 while the upper geometry is rotated by an upper geometry shaft 18 held by the rheometer. A temperature control unit (TCU) 20 controls the temperature near the lower geometry, and an optional hood 22 can help control the temperature near the upper geometry.

The hood 22 can be either passive or active in the temperature control process. A passive hood is one that contains no temperature controlling elements. It typically employs a heat spreader only, which is indirectly coupled to the heat pump controlling the lower geometry. An active hood is one that utilizes active temperature control of the upper geometry. The purpose of active hood control is typically to reduce the heat losses that give rise to temperature gradients within the sample.

In the context of this document the term heat pump is used to describe a device that can both add and remove heat from a part. Example heat pumps include a Joule Peltier device or more commonly a heater/cooler unit such as can be found in air conditioning systems. The term heater is used for a device that will add heat only, and a cooler is used for devices that only remove heat.

Several approaches are known for reducing the temperature variations across the sample in a rheometer. In one approach that uses a passive hood, shown in FIG. 2, a single heat pump is used to control lower geometry temperature (T_{L}), and heat flux through the sample (Qₛₐₘₚₗₑ) is minimized by using low thermal conductivity materials to form an inner lining with an insulating hood. This type of hood can use its inner lining to heat or cool the shaft, use its inner lining to radiate heat to the area surrounding the upper geometry, and/or use its insulating lining to reduce heat exchange with the rheometer's surroundings.

The temperature at the top of the upper geometry (T_{T}) will be close to ambient because it is mechanically attached to the Rheometer, so as T_{L} moves away from ambient, heat flows through the sample and the upper geometry shaft. The temperature difference across the sample (T_{L}−T_{U}) depends on the nature of the sample and the amount of heat flux through the sample, and can be reduced by reducing the heat flux. This reduction can be accomplished by increasing the length of the shaft, by changing the shaft material, or by using a hollow shaft. Even with the best materials, however, only a modest improvement can be achieved before the mechanical compliance of the shaft compromises the ability of the rheometer to make good measurements. As a result, passive hood concepts often cannot limit the temperature difference across a sample sufficiently over a wide range of temperature.

As shown in FIG. 3, another approach involves an active hood, which can allow the heat flux through the sample to be reduced by having a second temperature controlled element in the hood. If the collar around the shaft is controlled to a specific temperature, for example, it can be arranged so that all the heat flux that flows to the rheometer is supplied by the collar. The heat flux through the sample can thus be zero and the temperature difference across the sample can therefore also be zero.

When the sample (T_{L}) is required to be hotter than ambient, the collar temperature must be even hotter than the sample. Conversely, when the sample is required to be colder than ambient, the collar temperature must be even colder than the sample. Known methods for heating and cooling the collar include:

Providing a solid-state bi-directional heat pump (e.g., a Peltier device) in the hood

Providing a remote source of hot and cold fluid and a valve system

Combination systems, e.g., using a fluid-based cooler and a separate heater

Active hood concepts with heat pumps in the hood can be complex, expensive to build, and awkward to use because of the cooling pipes needed for the heat pumps. Active hood concepts with hot and cold gas streams can require large surface areas on the upper geometry, which can reduce measurement performance because of increased mechanical inertia. And the requirement to generate a cold gas stream can be expensive and noisy.

### SUMMARY OF THE INVENTION

In one general aspect, the invention features a rheometer for measuring properties of a sample. It includes a first part having a drive portion operatively connected to an actuator and having a contact surface for contacting the sample. It also includes a second part that has another contact surface for contacting the sample. A first heater is positioned to heat the first part, a second heater is positioned to heat the second part, and a heat pump can heat and cool both the first and second parts.

In preferred embodiments the first part can include a shaft between its contact surface and its drive portion, with the rheometer further including a hood with an opening for the shaft, and with the first heater being located on the hood proximate the opening for the shaft. The actuator can be a rotary actuator. The first part can be a top part with the second part being a bottom part, and with the heat pump being placed below the bottom part. The second heater can be attached to a heat spreader operative to maximize heat coupling between the heater and the second part. The first part can be is a top part, with the second part being a bottom part, and with the heat pump being placed below the bottom part. The heat pump can include a Peltier device. The actuator can be is a rotary actuator The heaters can be resistive heaters. The rheometer can further include a controller having an output operatively connected to at least one of the first heater, the second heater, and the heat pump. The controller can include temperature control logic operative to minimize heat flux through the sample. The rheometer can further include a lower heat spreader operatively connected to the heat pump and at least one lower heat spreader temperature sensor, with the controller having an input responsive to the lower heat spreader temperature sensor. The controller can have an input responsive to an ambient sensor. The rheometer can further include a shaft between the actuator and the drive portion of the first part and a temperature sensor for the shaft, with the controller having an input responsive to the shaft temperature sensor. The rheometer can further include an input operatively connected to at least one temperature sensor within the rheometer. A predetermined sample temperature can be higher than ambient with the controller being operative to control the heat pump and the first heater. A predetermined sample temperature can be lower than ambient with the controller being operative to control the heat pump and the second heater. A predetermined sample temperature can be varied above and below ambient with the temperature control system being operative to control the heat pump in combination with one of either the first heater or the second heater accordingly. A temperature of the first part can be monitored by an integral first temperature sensor proximate the sample, a temperature of the second part can be monitored by an integral second temperature sensor proximate the sample, and an ambient temperature can be monitored by a suitably positioned third temperature sensor, with the controller being responsive to all three of the temperature sensors in order to achieve a predetermined sample temperature with a minimum heat flux through the sample.

In another general aspect, the invention features a rheometry method that includes setting an overall rheometer temperature, heating a first part of the rheometer to reduce the heat flux through a sample when the sample temperature is above ambient, heating a second part of the rheometer to reduce the heat flux through the sample when the sample temperature is below ambient, moving at least one of the first and second parts with respect to the other, and measuring a property of the sample based on effects on the sample of the step of moving.

In preferred embodiments the step of setting an overall rheometer temperature can include a cooling step. The step of setting an overall rheometer temperature can include a heating step. The step of setting an overall rheometer temperature can be performed by a Peltier device. The first part can be a top part, the second part can be a bottom part, and the step of setting an overall rheometer temperature can be performed from below. The step of moving can include rotating the top part or the first part.

Systems according to the invention can be advantageous in that they can allow a rheometer to minimize temperature variations across a sample without the complexities or inaccuracies that can result from use of prior art passive and active hoods. Rheometers according to the invention can therefore be more compact, less expensive to build, more precise to operate, and easier to use. Systems according to the invention can also benefit from a broader temperature range without added complexity. This can allow them to easily characterize a wide range of substances, such as thermoplastics, elastomers, asphalt, thermo-sets, pressure sensitive adhesives, and ice cream.

### BRIEF DESCRIPTION OF THE DRAWINGS

FIG. 1 is a diagrammatic cross-sectional drawing illustrating a basic prior art rheometer arrangement;

FIG. 2 is a diagrammatic cross-sectional drawing illustrating a prior art passive-hood rheometer arrangement and showing heat paths within the rheometer;

FIG. 3 is a diagrammatic cross-sectional drawing illustrating a prior art active-hood rheometer arrangement and showing heat paths within the rheometer;

FIG. 4 is a diagrammatic cross-sectional drawing of an illustrative rheometer according to the invention;

FIG. 5 is a heat transfer diagram showing the rheometer of FIG. 4 in a situation where the sample measurement temperature is above ambient; and

FIG. 6 is a heat transfer diagram showing the rheometer of FIG. 4 in a situation where the sample measurement temperature is below ambient.

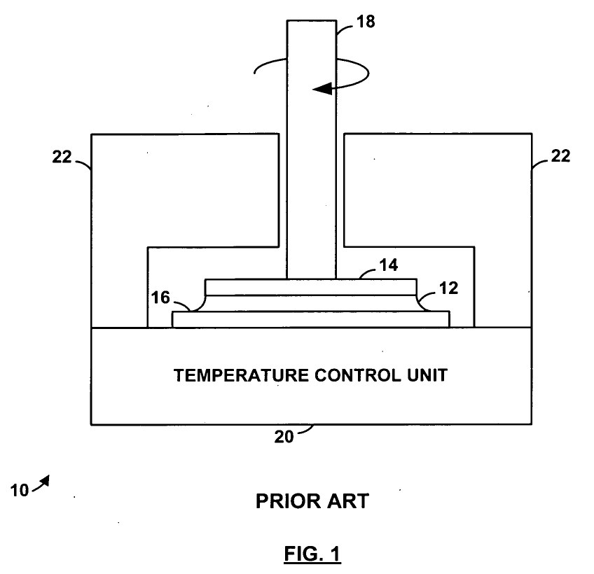

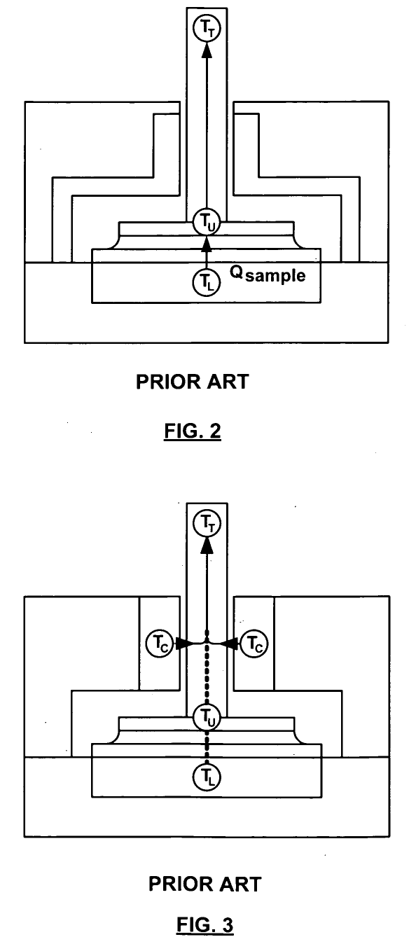

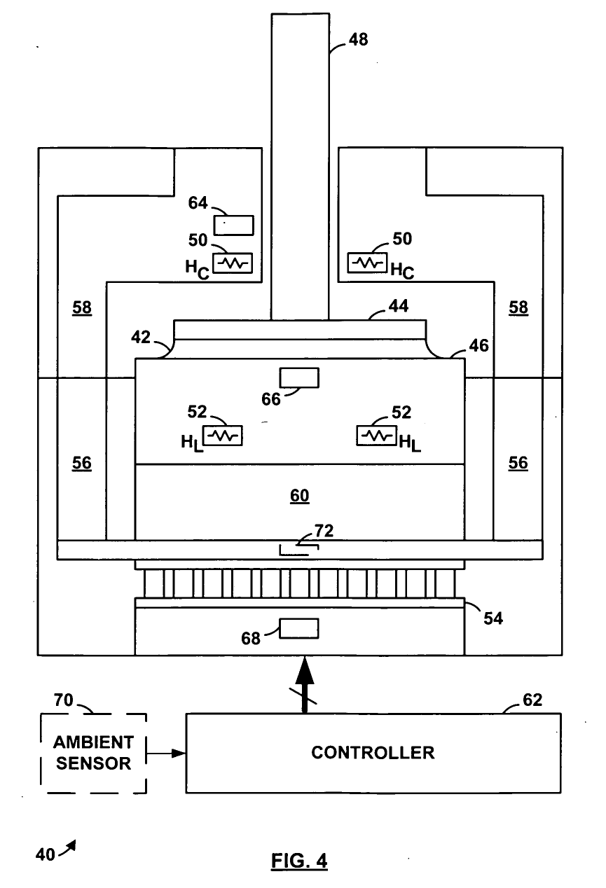

### DETAILED DESCRIPTION OF AN ILLUSTRATIVE EMBODIMENT

Referring to FIG. 4, an illustrative rheometer 40 according to the invention can include one or more upper geometry heaters 50 and one or more lower geometry heaters 52. The upper geometry heaters are preferably placed proximate some part of the rheometer's upper geometry 44, such as proximate an upper geometry shaft within a collar that surrounds it. The lower geometry heaters are preferably placed proximate to, or embedded in, the rheometer's lower geometry 46.

A heat pump 54 can be provided below the lower geometry 46, and one or more lower heat spreaders 56 can spread heat around in the lower part of the rheometer. The heat spreaders preferably also contact upper heat spreaders 58, which spread heat around the upper part of the rheometer. Generally, a heat spreader can include a single thermally conductive part, or a set of connected parts, that are in thermal connection with a heater, cooler, or heat pump. Its function is to thermally temper a nearby region by spreading the heat efficiently so that a uniform temperature is achieved. The lower geometry heaters 52 are preferably separated from the heat pump by a thermal spacer 60.

A controller 62 controls temperature for the rheometer 40. It has inputs to receive collar temperature signals from a collar sensor 64, lower geometry temperature signals from a lower geometry sensor 66, heat pump temperature signals from a heat pump sensor 68, ambient temperature signals from an ambient sensor 70, and/or heat spreader temperature signals from a heat spreader temperature sensor 72. The controller can also have outputs to provide control signals to the upper heaters 50, the lower heaters 52, and/or the heat pump 54. The embodiment can be part of an environmental controller that controls temperature and possibly other environmental variables. It can also be part of a larger control system that controls other parts of the rheometer.

The controller can employ special-purpose-software running on a general-purpose computer, dedicated special-purpose hardware, or a combination of the two. It can be based on of-the-shelf controller products or it can be designed from the ground up for a particular instrument. Any suitable control methodology can be employed, such as ones that use digital or analog controllers that implement proportional and/or adaptive control laws. In the present embodiment, the controller 62 that controls temperature in the instrument includes three software-based Proportional-Integral-Derivative (PID) controllers.

The controller uses its control methodology to derive one or more control signals from one or more sensor signals. For example, it can derive control signals for the heat pump, the upper heaters, and the lower heaters from a heat sensor on or near the collar, a heat sensor on or near the lower geometry, and a heat pump sensor. It can also use other sensor and control signal permutations, and additional sensors and controlled elements of different types can be used. For example, an optional ambient temperature sensor 70 placed outside the instrument allows the controller to additionally compensate the control loops for variations in ambient temperatures. A heat spreader temperature sensor 72 associated with the heat spreaders can also provide a baseline value to use in controlling the heat flux across the sample. Further, a shaft temperature sensor can allow the controller to optionally compensate for any increased heat coupled down the shaft to the upper geometry when the drive motor is running hot under load. These additional sensors optionally allow the controller to compensate for second order differences between the collar temperature and the upper sample face when the environmental conditions are not as modeled during calibration. The controller can control additional heating or cooling elements, and it can also control other variables such as pressure, either directly, or indirectly.

The heaters provided in the hood and to the lower geometry can be controlled in such a way as to achieve zero heat flux through the sample without the need for a second heat pump or cold source. In place of controllable heating and cooling in the hood, the collar can be made hotter or colder than the sample as required, by using just heaters. If the collar needs to be hotter than the sample, then the hood heaters can be used. When the sample needs to hotter than the collar, then the lower geometry heaters can be used.

The thermal path between the collar and the sample preferably has a carefully controlled thermal impedance so that only a modest amount of heat needs to flow from the hood or lower geometry heaters to get the required temperature differences needed to the zero heat flux conditions. Unless a means of measuring the upper geometry temperature or sample heat flux is available, a calibration experiment can be used to determine the required collar temperature for a given range of sample temperatures.

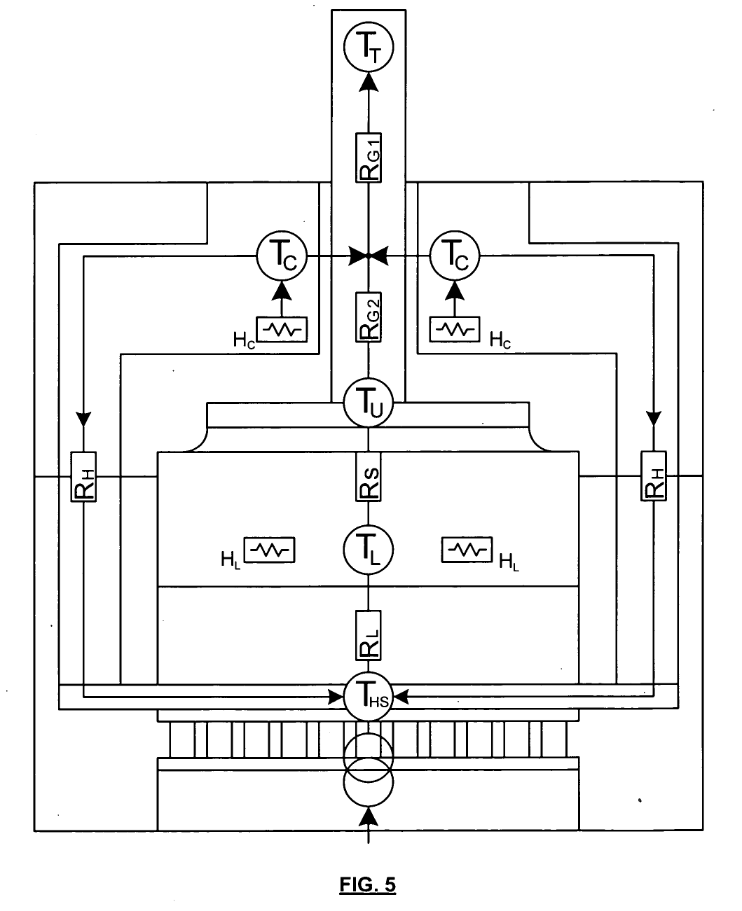

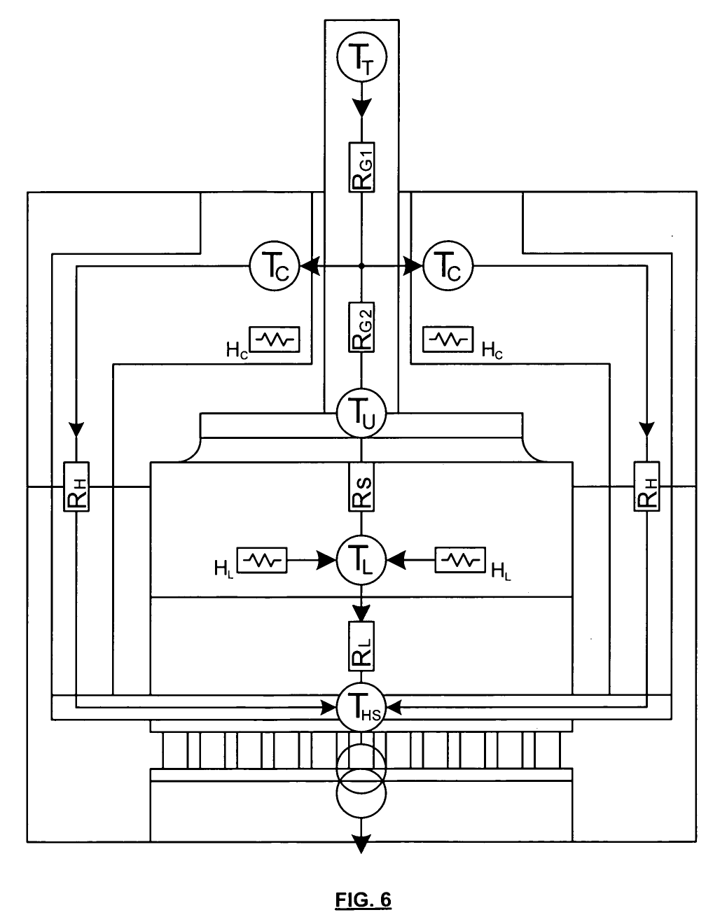

Referring to FIG. 5, when a sample is to be measured at a temperature above ambient, the hood heaters are supplied with power such that the collar is a predetermined amount hotter than the sample temperature, allowing zero heat flux through the sample to be achieved. The heat spreader temperature is very close to sample temperature.

R_{H} represents the thermal resistance between the hood and the heat spreader. R_{S} represents the thermal resistance of the sample. R_{G1} and R_{G2} represent the thermal resistance of the upper geometry shaft. R_{L} is the thermal resistance between the heat spreader and the lower geometry. Arrows show the direction of heat flux.

Referring to FIG. 6, when the sample temperature is to be below ambient, the hood collar needs to be colder than the sample. This is achieved by turning on the heaters in the lower geometry. The heat flux from these heaters flows though R_{L} making the lower geometry warmer than the heat spreader. With the hood heaters off, the collar will be at close to the heat spreader temperature. This allows the collar to be cold enough to achieve zero heat flux through the sample.

The thermal resistance between the lower geometry and the heat spreader, R_{L}, can be designed so that only a modest amount of power needs to be delivered to the lower geometry heaters to achieve zero heat flux through the sample. If the thermal resistance is too low, then a large amount power is needed to achieve a sufficient temperature difference, and this would require an oversized heat pump. If the thermal resistance is too large, the rate at which the sample can be cooled will be too slow.

One implementation for the present embodiment employs three temperature controllers one for the heat spreader, which drives the Peltier device, one for the heat exchanger; which drives a boost heater and cooler and one for the offset heaters, only one of which can be powered at a time. In addition, a setpoint calculator incorporates a PID controller to set the heatspreader setpoint so as to control the temperature of either the lower geometry or the collar, depending upon which of these has the lower required temperature at any one time.

An instantaneous lower geometry setpoint (output from the ramp limiter) and calibration data are used to calculate an instantaneous collar setpoint. If the instantaneous lower geometry setpoint is the lower of the two, the heatspreader setpoint is controlled such as to control the lower geometry temperature—the collar temperature is then controlled by the offset controller using the hood heater. If the instantaneous collar setpoint is the lower of the two, however, the heatspreader setpoint is controlled such as to control the collar temperature, with the lower geometry temperature being controlled by the offset controller using the sample heater.

The target temperature for the heat spreader PID controller is set by the setpoint calculator PID controller. The output of this PID controller is the power to be used on the heat spreader. Calculated heat contributions from the sample heater block and hood (based upon the current temperature of these parts and the known thermal resistances to them) is subtracted from this value, then the current temperature and temperature difference across the Peltier device is used to calculate the voltage to be applied to the Peltier to pump this amount of heat into/out of the heat spreader.

The target temperature for the heat exchanger is based upon the heat spreader temperature and the properties of the Peltier devices, chosen to maximise available ramp rates while keeping the devices within their specified safe working conditions. The output of this PID controller is the power to be used on the heat exchanger. Calculated heat pumped by the Peltier device to the heat exchanger (based upon the current temperature, temperature difference and voltage applied to the Peltier device) is subtracted from this and used to calculate the voltage to be applied to the boost heater to heat at this calculated rate. The boost heater cannot, of course, cool the heat exchanger so the heat exchanger temperature may rise above the target temperature; if this rises above a threshold, the cooler/recirculator is used to cool the heat exchanger.

The offset heater controller drives the hood heater and the lower geometry heater. These heaters can share a single bi-directional power channel, with a pair of diodes to determine which heater is to be used, so only one of these heaters may be powered at any one time in this implementation. This controller consists of two PID controllers—one for the hood heater and one for the sample block heater—and logic to select which to use at any one time. The selection is determined by which of the target collar temperature and target lower geometry temperature is the lower. The output of each PID controller is the power that needs to be used on the hood or the lower geometry heater block, which is then used to determine the voltage to be applied to the relevant heater to achieve this, adding the forward voltage drop across the diodes that are used to share this power channel between the two heaters.

As presented above, a shaft temperature sensor can also be provided. At high torque settings, the electric motor that rotates the shaft can become hot, causing heat energy to be transferred into the shaft. Conversely, at low torque settings very little heat energy may be coupled into the shaft. By measuring the temperature of the shaft, the controller can compensate for this.

The temperature control approach described above is applicable to all types of rheometers used to study the properties of liquids or solids, such as Dynamic Mechanical Thermal Analysis instruments, and it can also be applied to other types of benchtop materials characterization instruments. Rheometers using the environmental control approach presented above can in addition be implemented in modular systems such as are described in U.S. application No. 61/137,639 entitled RHEOMETER WITH MODULAR ENVIRONMENTAL CONTROL SYSTEM, which is herein incorporated by reference.

The present invention has now been described in connection with a number of specific embodiments thereof. However, numerous modifications which are contemplated as falling within the scope of the present invention should now be apparent to those skilled in the art. While the terms “upper” and “lower” are used throughout specification, it is possible to build rheometers that use other orientations, such as an upside down orientation. It is also possible to build a rheometer that rotates both the upper and lower parts, for actuation, sensing, or both.” It is therefore intended that the scope of the present invention be limited only by the scope of the claims appended hereto. In addition, the order of presentation of the claims should not be construed to limit the scope of any particular term in the claims.

What is claimed is:

1. A rheometer for measuring properties of a sample, comprising:
an actuator,
a first part having a contact surface for contacting the sample, and having a drive portion operatively connected to the actuator,
a first heater positioned to heat the first part,
a second part having a contact surface for contacting the sample,
a second heater positioned to heat the second part, and
a heat pump operative to heat and cool both the first and second parts.

2. The apparatus of claim 1 wherein the first part includes a shaft between its contact surface and its drive portion, wherein the rheometer further includes a hood with an opening for the shaft, and wherein the first heater is located on the hood proximate the opening for the shaft.

3. The apparatus of claim 2 wherein the actuator is a rotary actuator.

4. The apparatus of claim 2 wherein the first part is a top part, wherein the second part is a bottom part, and wherein the heat pump is placed below the bottom part.

5. The apparatus of claim 1 wherein the second heater is attached to a heat spreader operative to maximize heat coupling between the heater and the second part.

6. The apparatus of claim 1 wherein the first part is a top part, wherein the second part is a bottom part, and wherein the heat pump is placed below the bottom part.

7. The apparatus of claim 5 wherein the heat pump includes a Peltier device.

8. The apparatus of claim 1 wherein the heat pump includes a Peltier device.

9. The apparatus of claim 1 wherein the actuator is a rotary actuator

10. The apparatus of claim 1 wherein the heaters are resistive heaters.

11. The apparatus of claim 1 further including a controller having an output operatively connected to at least one of the first heater, the second heater, and the heat pump.

12. The apparatus of claim 11 wherein the controller includes temperature control logic operative to minimize heat flux through the sample.

13. The apparatus of claim 11 further including a lower heat spreader operatively connected to the heat pump, further including at least one lower heat spreader temperature sensor, and wherein the controller has an input responsive to the lower heat spreader temperature sensor.

14. The apparatus of claim 11 wherein the controller has an input responsive to an ambient sensor.

15. The apparatus of claim 11 further including a shaft between the actuator and the drive portion of the first part, further including a temperature sensor for the shaft, and wherein the controller has an input responsive to the shaft temperature sensor.

16. The apparatus of claim 11 further including an input operatively connected to at least one temperature sensor within the rheometer.

17. The apparatus of claim 11 wherein a predetermined sample temperature is higher than ambient and the controller is operative to control the heat pump and the first heater.

18. The apparatus of claim 11 wherein a predetermined sample temperature is lower than ambient and the controller is operative to control the heat pump and the second heater

19. The apparatus of claim 11 wherein a predetermined sample temperature can be varied above and below ambient and the temperature control system is operative to control the heat pump in combination with one of either the first heater or the second heater accordingly.

20. The apparatus of claim 11 wherein a temperature of the first part is monitored by an integral first temperature sensor proximate the sample, a temperature of the second part is monitored by an integral second temperature sensor proximate the sample, and an ambient temperature is monitored by a suitably positioned third temperature sensor, and wherein the controller is responsive to all three of the temperature sensors in order to achieve a predetermined sample temperature with a minimum heat flux through the sample.

21. The apparatus of claim 20 wherein the predetermined sample temperature is higher than ambient and the controller is operative to control the heat pump and the first heater.

22. The apparatus of claim 20 wherein the predetermined sample temperature is lower than ambient and the controller is operative to control the heap pump and the second heater.

23. The apparatus of claim 20 wherein the predetermined sample temperature can be varied above and below ambient and the temperature control system is operative to control the heat pump in combination with one of either the first heater or the second heater accordingly.

24. A rheometry method, comprising:
setting an overall rheometer temperature,
heating a first part of the rheometer to reduce the heat flux through a sample when the sample temperature is above ambient,
heating a second part of the rheometer to reduce the heat flux through the sample when the sample temperature is below ambient,
moving at least one of the first and second parts with respect to the other, and
measuring a property of the sample based on effects on the sample of the step of moving.

25. The method of claim 24 wherein the step of setting an overall rheometer temperature includes a cooling step.

26. The method of claim 24 wherein the step of setting an overall rheometer temperature includes a heating step.

27. The method of claim 24 wherein the step of setting an overall rheometer temperature is performed by a Peltier device.

28. The method of claim 24 wherein the first part is a top part, the second part is a bottom part, and wherein the step of setting an overall rheometer temperature is performed from below.

29. The method of claim 28 wherein the step of moving includes rotating the top part.

30. The method of claim 24 wherein the step of moving includes rotating the first part.

31. A rheometer for measuring properties of a sample, comprising:
means for setting an overall rheometer temperature,
means for heating a first part of the rheometer to reduce the heat flux through a sample when the sample temperature is above ambient,
means for heating a second part of the rheometer to reduce the heat flux through the sample when the sample temperature is below ambient,
means for moving at least one of the first and second parts with respect to the other, and
means for measuring a property of the sample based on effects on the sample of the means for moving.
